(19) United States
(12) Patent Application Publication
(10) Pub. No.: US 2025/0109808 A1
(43) Pub. Date: Apr. 3, 2025

(54) HOSE FOR REFRIGERANT TRANSPORTATION AND PRODUCTION METHOD THEREFOR

(71) Applicant: THE YOKOHAMA RUBBER CO., LTD., Kanagawa (JP)

(72) Inventors: Kenta WAKABAYASHI, Kanagawa (JP); Miyuki NISHI, Kanagawa (JP)

(21) Appl. No.: 18/850,932

(22) PCT Filed: Dec. 12, 2022
(86) PCT No.: PCT/JP2022/045680

§ 371 Date: Sep. 25, 2024

(30) Foreign Application Priority Data
Mar. 30, 2022 (JP) 2022-056698
Sep. 29, 2022 (JP) 2022-156953
Sep. 29, 2022 (JP) 2022-157013

(51) Int. Cl. F16L 11/08; B32B 1/08; B32B 25/08; B32B 25/18; B32B 27/32; F16L 11/04; F25B 41/40

(52) U.S. Cl. CPC F16L 11/08; B32B 1/08; B32B 25/08; B32B 25/18; B32B 27/32; F25B 41/40; B32B 2305/72; B32B 2307/54; B32B 2307/7246; F16L 2011/047

(57) ABSTRACT

A hose for refrigerant transportation includes an outer layer, a reinforcing layer, and an inner layer. The outer layer is composed of a resin composition containing elastomer having a polyisobutylene backbone and crosslinked resin. A content of the elastomer having a polyisobutylene backbone in the resin composition is 30 mass % or more and 90 mass % or less with respect to a mass of the resin composition. A content of the crosslinked resin in the resin composition is 10 mass % or more and 70 mass % or less with respect to the mass of the resin composition. A water vapor permeability of the resin composition is 2.0 g·mm/(m²·24 h) or less. A ratio TB₁₀₀/TB₂₅ of a strength at break TB₁₀₀ of the resin composition at 100° C. to a strength at break TB₂₅ of the resin composition at 25° C. is from 0.2 to 1.0.

### TECHNICAL FIELD

The present technology relates to a hose for refrigerant transportation and a production method therefor. The present technology relates more particularly to a hose for refrigerant transportation to be used for an air conditioner of an automobile and a method for producing the hose for refrigerant transportation.

### BACKGROUND ART

With the increasing demand for weight reduction of automobiles, efforts have been made to achieve the weight reduction by producing a hose that has been used for automobiles and is made of rubber with resin having high barrier properties in place of rubber to reduce thickness. In particular, a hose for refrigerant transportation for current automobile air conditioners is composed mainly of rubber. If the main material can be substituted with resin having high barrier properties, a weight reduction can be achieved.

Japan Unexamined Patent Publication No. H04-145284 A describes a hose for transporting a refrigerant such as Freon gas. An outer tube of the hose is made of thermoplastic elastomer composed of thermoplastic polyolefin resin and EPDM (ethylene propylene diene monomer) or butyl rubber.

An air conditioner of an automobile and the like are installed in a limited, narrow space in the automobile, and thus the hose for refrigerant transportation is required to have excellent flexibility and easy installation even in a narrow space. Permeation of water vapor from an outer side of a hose causes freezing of moisture inside an air conditioner, and thus a material forming an outer tube of the hose for refrigerant transportation is required to have excellent water vapor barrier properties. Furthermore, the hose for refrigerant transportation needs to be durable enough to withstand long-term use in the high-temperature and high-humidity environment inside an engine room.

However, because an outer tube of a resin hose described in Japan Unexamined Patent Publication No. H04-145284 A is made of thermoplastic elastomer containing thermoplastic polyolefin resin, heat resistance is not necessarily sufficient.

### SUMMARY

The present technology provides a hose for refrigerant transportation having excellent flexibility, water vapor barrier properties, and heat resistance.

An embodiment of the present technology is a hose for refrigerant transportation including an outer layer, a reinforcing layer, and an inner layer. The outer layer is composed of a resin composition containing elastomer having a polyisobutylene backbone and crosslinked resin. A content of the elastomer having a polyisobutylene backbone in the resin composition is 30 mass % or more and 90 mass % or less with respect to a mass of the resin composition. A content of the crosslinked resin in the resin composition is 10 mass % or more and 70 mass % or less with respect to the mass of the resin composition. A water vapor permeability of the resin composition is 2.0 g·mm/(m²·24 h) or less. A ratio TB₁₀₀/TB₂₅ of a strength at break TB 100 of the resin composition at 100° C. to a strength at break TB₂₅ of the resin composition at 25° C. is from 0.2 to 1.0.

An embodiment of the present technology is a method for producing the hose for refrigerant transportation of the embodiment of the present technology. The method includes: preparing a composition for an outer layer by melt-kneading elastomer having a polyisobutylene backbone and crosslinkable resin; and forming an outer layer by adding a silanol condensation catalyst to the composition for an outer layer during hose extrusion molding and extrusion molding a composition to which a silanol condensation catalyst is added.

The present technology includes the following embodiments.

[1] A hose for refrigerant transportation including an outer layer, a reinforcing layer, and an inner layer.

In the hose, the outer layer is composed of a resin composition containing elastomer having a polyisobutylene backbone and crosslinked resin,
a content of the elastomer having a polyisobutylene backbone in the resin composition is 30 mass % or more and 90 mass % or less with respect to a mass of the resin composition,
a content of the crosslinked resin in the resin composition is 10 mass % or more and 70 mass % or less with respect to the mass of the resin composition,
a water vapor permeability of the resin composition is 2.0 g·mm/(m²·24 h) or less, and
a ratio TB₁₀₀/TB₂₅ of a strength at break TB₁₀₀ of the resin composition at 100° C. to a strength at break TB₂₅ of the resin composition at 25° C. is from 0.2 to 1.0.

[2] The hose for refrigerant transportation according to [1], wherein the crosslinked resin is crosslinked silane-modified resin obtained by modifying thermoplastic resin with a silane compound.

[3] The hose for refrigerant transportation according to [2], wherein the crosslinked resin is crosslinked silane-modified polyolefin obtained by modifying polyolefin with a silane compound.

[4] The hose for refrigerant transportation according to [3], wherein the crosslinked resin is crosslinked silane-modified polypropylene obtained by modifying polypropylene with a silane compound.

[5] The hose for refrigerant transportation according to any one of [1] to [4], wherein the elastomer having a polyisobutylene backbone is butyl rubber or modified butyl rubber, and the elastomer having a polyisobutylene backbone is dynamically crosslinked.

[6] The hose for refrigerant transportation according to any one of [1] to [5], wherein the resin composition contains 1 mass % or more and 4 mass % or less of an anti-aging agent with respect to the mass of the resin composition.

[7] The hose for refrigerant transportation according to any one of [1] to [6], wherein
the inner layer is composed of a thermoplastic resin composition,
the thermoplastic resin composition has an islands-in-the-sea structure in which elastomer is present as a domain in a matrix containing the thermoplastic resin,
the thermoplastic resin contains 50 mass % or more and 100 mass % or less of polyamide with respect to the mass of the thermoplastic resin,
the elastomer contains the elastomer having a polyisobutylene backbone,
a content of the elastomer is 30 mass % or more and 80 mass % or less with respect to the mass of the thermoplastic resin composition, and
the thermoplastic resin composition further contains a phenylenediamine-based or quinoline-based anti-aging agent and a processing aid.

[8] The hose for refrigerant transportation according to any one of [1] to [7], wherein the reinforcing layer contains a polyester fiber, a polyamide fiber, an aramid fiber, a PBO (poly(p-phenylene-2,6-benzobisoxazole) fiber, a vinylon fiber, or a rayon fiber.

[9] A method for producing the hose for refrigerant transportation according to any one of [1] to [8].

The method includes: preparing a composition for an outer layer by melt-kneading elastomer having a polyisobutylene backbone and crosslinkable resin; and forming an outer layer by adding a silanol condensation catalyst to the composition for an outer layer during hose extrusion molding and extrusion molding a composition to which the silanol condensation catalyst is added.

[10] The method according to [9], wherein the crosslinkable resin is silane-modified resin obtained by modifying thermoplastic resin with a silane compound.

The hose for refrigerant transportation of an embodiment of the present technology has excellent flexibility, water vapor barrier properties, and heat resistance.

### BRIEF DESCRIPTION OF DRAWINGS

FIG. 1 is a cross-sectional view of a hose for refrigerant transportation.

FIG. 2 is a diagram illustrating an evaluation method of flexibility of a hose.

### DETAILED DESCRIPTION

An embodiment of the present technology relates to a hose for refrigerant transportation.

The hose for refrigerant transportation is referred to as a hose for transporting a refrigerant for an air conditioner or the like. The hose for refrigerant transportation of an embodiment of the present technology is particularly suitably used as a hose for transporting a refrigerant of an air conditioner of an automobile. Examples of the air conditioner refrigerant include hydrofluorocarbons (HFCs), hydrofluoroolefins (HFOs), hydrocarbons, carbon dioxide, ammonia, and water. Examples of the HFC include R410A, R32, R404A, R407C, R507A, and R134a. Examples of the HFO include R1234yf, R1234ze, 1233zd, R1123, R1224yd, and R1336mzz. Examples of the hydrocarbon include methane, ethane, propane, propylene, butane, isobutane, hexafluoropropane, and pentane.

The hose for refrigerant transportation of an embodiment of the present technology includes an outer layer, a reinforcing layer, and an inner layer.

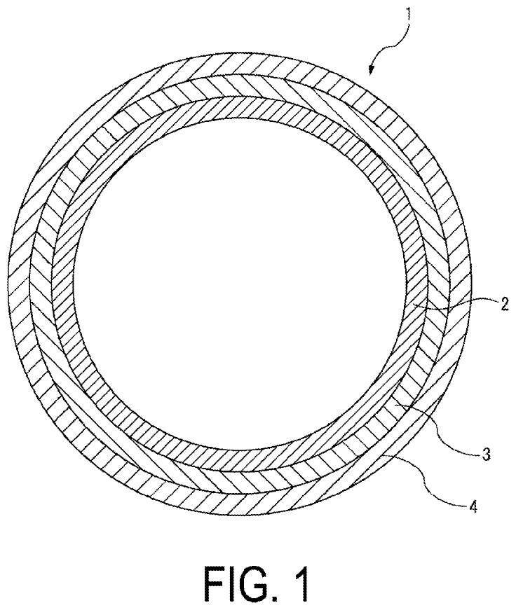

FIG. 1 is a cross-sectional view of a hose for refrigerant transportation of an embodiment of the present technology. However, an embodiment of the present technology is not limited to what is illustrated in FIG. 1.

The hose 1 for refrigerant transportation includes an inner layer 2, a reinforcing layer 3 disposed on the outer side of the inner layer 2, and an outer layer 4 disposed on the outer side of the reinforcing layer 3.

The outer layer is composed of a resin composition containing elastomer having a polyisobutylene backbone and crosslinked resin.

The elastomer having a polyisobutylene backbone is not limited as long as the elastomer has a polyisobutylene backbone but is preferably a butyl rubber (IIR), a modified butyl rubber, or a styrene-isobutylene-styrene block copolymer, and is more preferably a butyl rubber or a modified butyl rubber.

The polyisobutylene backbone refers to a chemical structure formed by polymerization of a plurality of isobutylene, that is, a chemical structure represented by —[—CH₂—C(CH₃)₂-]ₙ— (however, n is an integer of 2 or more).

The butyl rubber refers to an isobutylene-isoprene copolymer obtained by copolymerizing isobutylene and a small amount of isoprene and is abbreviated as IIR.

The modified butyl rubber refers to a butyl rubber, in which a double bond, a halogen, and the like are present in an isoprene backbone. As the modified butyl rubber, a halogenated butyl rubber is preferred, a brominated butyl rubber and a chlorinated butyl rubber are more preferred, and a brominated butyl rubber is even more preferred.

A styrene-isobutylene-styrene block copolymer is abbreviated as SIBS.

Because the resin composition contains the elastomer having a polyisobutylene backbone, flexibility and water vapor barrier properties of the resin composition are improved.

The elastomer having a polyisobutylene backbone is preferably dynamically crosslinked. The dynamic crosslinking improves durability.

The content of the elastomer having a polyisobutylene backbone is 30 mass % or more and 90 mass % or less, preferably 40 mass % or more and 89 mass % or less, and more preferably 50 mass % or more and 88 mass % or less, with respect to the mass of the resin composition. When the content of the elastomer having a polyisobutylene backbone is too small, flexibility cannot be ensured. When the content is too large, extrudability deteriorates.

The resin composition contains a crosslinked resin. The resin composition achieves excellent heat resistance because the resin composition contains a crosslinked resin.

The crosslinked resin refers to resin that is crosslinked. The crosslinked resin is not limited but is preferably a crosslinked resin to which a silane-modified resin is crosslinked. The silane-modified resin refers to resin obtained by modifying thermoplastic resin with a silane compound. The silane-modified resin is preferably resin obtained by modifying polyolefin-based thermoplastic resin with a silane compound and is more preferably crosslinkable resin having a hydrolyzable silyl group (preferably an alkoxysilyl group) obtained by modifying polyolefin-based thermoplastic resin with a silane compound.

That is, the crosslinked resin is preferably crosslinked silane-modified resin obtained by modifying thermoplastic resin with a silane compound, more preferably crosslinked silane-modified polyolefin obtained by modifying polyolefin with a silane compound, and even more preferably crosslinked silane-modified polypropylene obtained by modifying a polypropylene with a silane compound.

The silane compound is not limited but is preferably a compound represented by Formula (1).

R¹—SiR²ₙY₃₋ₙ (1)

R¹ is an ethylenic unsaturated hydrocarbon group, R² is a hydrocarbon group, Y is a hydrolyzable organic group, and n is an integer of 0 to 2.

R¹ is preferably an ethylenic unsaturated hydrocarbon group having the carbon number of 2 to 10, and examples thereof include a vinyl group, a propenyl group, a butenyl group, a cyclohexenyl group, and a γ-(meth)acryloyloxypropyl group.

R² is preferably a hydrocarbon group having the carbon number of 1 to 10, and examples thereof include a methyl group, an ethyl group, a propyl group, a decyl group, and a phenyl group.

Y is preferably a hydrolyzable organic group having the carbon number of 1 to 10, and examples thereof include a methoxy group, an ethoxy group, a formyloxy group, an acetoxy group, a propionyloxy group, an alkyl amino group, and an arylamino group.

Specific examples of the silane compound include vinyltrimethoxysilane, vinyltriethoxysilane, vinyltriacetoxysilane, and γ-methacryloyloxypropyltrimethoxysilane. Among these, vinyltrimethoxysilane is preferred.

The polyolefin-based thermoplastic resin constituting the silane-modified resin is not limited, and examples thereof include polyethylene, a copolymer of ethylene and α-olefin, polypropylene, and a copolymer of propylene and another α-olefin. Polypropylene and a copolymer of propylene and another α-olefin are preferred, and polypropylene is particularly preferred.

The hydrolyzable silyl group refers to a group generating a silanol group (≡Si—OH) by hydrolysis and is preferably a group represented by Formula (2).

—SiR²ₙY₃₋ₙ (2)

However, R² and Y are as described above.

The crosslinkable resin refers to resin that can undergo a crosslinking reaction but is not crosslinked yet. The type of crosslinking reaction is not limited and may be a crosslinking by a peroxide but is preferably a crosslinking by moisture (water crosslinking).

The method of modifying with a silane compound is not limited and examples thereof include grafting and copolymerization. The grafting is a method of adding a silane compound to resin by a grafting reaction and is more specifically a reaction of generating a carbon radical by cleaving a carbon-hydrogen bonding of polyolefin and adding a silane compound having an ethylenic unsaturated hydrocarbon group to the carbon radical. The modification can be preferably performed by melt-kneading resin and a silane compound of Formula (1) in the presence of a radical generator, such as an organic peroxide. The copolymerization can be preferably performed by radical copolymerization of a monomer constituting resin and a silane compound of Formula (1).

The silane-modified resin is preferably a silane-modified polypropylene. The silane-modified resin is commercially available, and a commercially available product can be used as a silane-modified resin used for an embodiment of the present technology. Examples of the commercially available product of the silane-modified resin include “Linklon” (trade name) available from Mitsubishi Chemical Corporation.

The content of the crosslinked resin is 10 mass % or more and 70 mass % or less, preferably 11 mass % or more and 60 mass % or less, and more preferably 12 mass % or more and 50 mass % or less, with respect to the mass of the resin composition. When the content of the crosslinked resin is too small, extrudability becomes poor. When the content is too large, flexibility cannot be ensured.

The resin composition may contain resin other than the crosslinked resin. Examples of resin other than the crosslinked resin include polyolefin resin and polyamide resin. Examples of the polyolefin resin include polypropylene. Blending of the polypropylene in addition to the crosslinked resin forms a phase structure that tends to exhibit strength during heating because the viscosity of the resin component becomes stable. Furthermore, because the water vapor barrier properties of the polypropylene are good, the water vapor barrier properties of the entire composition become good.

In a case where the resin composition contains resin other than the crosslinked resin, the content of the resin other than the crosslinked resin is preferably 1 mass % or more and 60 mass % or less, more preferably 2 mass % or more and 55 mass % or less, and even more preferably 3 mass % or more and 50 mass % or less, with respect to the mass of the resin composition.

The water vapor permeability of the resin composition is 2.0 g·mm/(m²·24 h) or less, and preferably 1.9 g·mm/(m²·24 h) or less.

When the water vapor permeability is too high, moisture in the outside air penetrates into the hose for refrigerant transportation and can cause freezing of moisture inside the air conditioner. An embodiment of the present technology effectively blocks the intrusion of moisture from the outside by using, as the material constituting the outer layer, a material that is less likely to allow the permeation of water vapor.

The water vapor transmission coefficient is defined as follows. The water vapor transmission coefficient is the amount of water vapor that permeates a thickness of 1 mm per 1 m² of surface area in 24 hours under stipulated temperature and humidity conditions.

The water vapor permeability is measured at a temperature of 60° C. and a relative humidity of 95% by using a water vapor permeability tester.

The resin composition has a ratio TB₁₀₀/TB₂₅ of the strength at break TB₁₀₀ at 100° C. to the strength at break TB₂₅ at 25° C. of 0.2 or more and 1.0 or less, preferably 0.3 or more and 1.0 or less, and more preferably 0.35 or more and 1.0 or less. When the TB₁₀₀/TB₂₅ is closer to 1.0, better heat resistance is achieved. By use of the crosslinked resin, the TB₁₀₀/TB₂₅ falls within the numerical range described above, and heat resistance is improved.

The strength at break can be measured in accordance with the measurement method specified in JIS (Japanese Industrial Standard) K 6251 “Rubber, vulcanized or thermoplastics-Determination of tensile stress-strain properties”.

The resin composition preferably contains a silanol condensation catalyst. When the silanol condensation catalyst is contained, crosslinking of the silane-modified resin is promoted during formation of the crosslinked resin.

Examples of the silanol condensation catalyst include, but not limited to, a metal organic acid salt, a titanate, a borate, an organic amine, an ammonium salt, a phosphonium salt, an inorganic acid, an organic acid, and an inorganic acid ester.

Examples of the metal organic acid salt include, but not limited to, dibutyltin dilaurate, dioctyltin dilaurate, dibutyltin diacetate, dibutyltin dioctoate, tin (II) acetate, tin (II) octanoate, cobalt naphthenate, lead octylate, lead naphthenate, zinc octylate, zinc caprylate, iron 2-ethylhexanoate, iron octylate, and iron stearate.

Examples of the titanate include, but not limited to, tetrabutyl titanate, tetranonyl titanate, and bis(acetylacetonitrile) di-isopropyl titanate.

Examples of the organic amine include, but not limited to, ethylamine, dibutylamine, hexylamine, triethanolamine, dimethyl soya amine, tetramethylguanidine, and pyridine.

Examples of the ammonium salt include, but not limited to, ammonium carbonate and tetramethylammonium hydroxide.

Examples of the phosphonium salt include, but not limited to, tetramethylphosphonium hydroxide.

Examples of the inorganic acid include, but not limited to, sulfuric acid and hydrochloric acid.

Examples of the organic acid include, but not limited to, acetic acid, stearic acid, maleic acid, toluenesulfonic acid, and sulfonic acid such as alkylnaphthylsulfonic acid. Examples of the inorganic acid ester include, but not limited to, a phosphoric acid ester.

The silanol condensation catalyst is preferably a metal organic acid salt, sulfonic acid, or a phosphoric acid ester, and more preferably a metal carboxylate of tin such as dioctyltin dilaurate, alkylnaphthylsulfonic acid, and ethylhexyl phosphate. One type of silanol condensation catalyst may be used alone, or two or more types of the silanol condensation catalysts may be appropriately combined and used.

The content of the silanol condensation catalyst is not particularly limited but is preferably from 0.0001 to 0.5 parts by mass, and more preferably from 0.0001 to 0.3 parts by mass, with respect to 100 parts by mass of the silane-modified resin.

The silanol condensation catalyst is preferably used as a silanol condensation catalyst-containing master batch in which resin and a silanol condensation catalyst are blended. Examples of the resin that can be used for this silanol condensation catalyst-containing master batch include a polyolefin, and a polyethylene, a polypropylene, and a copolymer of these are preferred.

In a case where the silanol condensation catalyst is used as a silanol condensation catalyst-containing master batch in which resin and a silanol condensation catalyst are blended, the content of the silanol condensation catalyst in the master batch is preferably, but not limited to, from 0.1 to 5.0 mass %. A commercially available product may be used as the silanol condensation catalyst-containing master batch, and for example, “PZ010”, available from Mitsubishi Chemical Corporation, can be used.

The resin composition preferably contains an anti-aging agent. The anti-aging agent being contained makes extrusion moldability during molding of a resin composition before crosslinking good.

Examples of the anti-aging agent include, but not limited to, a hindered phenol-based antioxidant, a phenol-based antioxidant, an amine-based antioxidant, a phosphorus-based heat stabilizer, a metal deactivator, and a sulfur-based heat resistant stabilizer, and a hindered phenol-based antioxidant is preferred, and a hindered phenol-based antioxidant having a pentaerythritol ester structure is more preferred. Specific examples of the hindered phenol-based antioxidant include IRGANOX (trade name) 1010 (pentaerythritol tetrakis [3-(3,5-di-tert-butyl-4-hydroxyphenyl) propionate]), available from BASF Japan Ltd.

The content of the anti-aging agent is preferably 1 mass % or more and 4 mass % or less, and more preferably 1 mass % or more and 3.5 mass % or less, with respect to the mass of the resin composition.

The resin composition can contain elastomer other than the elastomer having a polyisobutylene backbone, resin other than the silane-modified resin, and an additive other than the silanol condensation catalyst and the anti-aging agent in a range that does not impair the effect of the present technology.

The resin composition may have any phase structure but preferably has an islands-in-the-sea structure or a co-continuous structure, and more preferably has an islands-in-the-sea structure composed of a matrix (sea phase) containing crosslinked resin and a domain (island phase) containing elastomer having a polyisobutylene backbone dispersed in the matrix, where the matrix is crosslinked. The crosslinking of the matrix contributes to heat resistance. In a case of the co-continuous structure, excellent flexibility is achieved.

The reinforcing layer, which is not limited, is, for example, a layer of braided fibers.

The reinforcing layer preferably contains, but not limited to, a polyester fiber, a polyamide fiber, an aramid fiber, a PBO fiber, a vinylon fiber, or a rayon fiber.

The inner layer is preferably composed of, but not limited to, a thermoplastic resin composition. The thermoplastic resin composition has an islands-in-the-sea structure in which elastomer is present as a domain in a matrix containing the thermoplastic resin. The thermoplastic resin contains 50 mass % or more and 100 mass % or less of polyamide with respect to the mass of the thermoplastic resin. The elastomer contains the elastomer having a polyisobutylene backbone. A content of the elastomer is 30 mass % or more and 80 mass % or less with respect to the mass of the thermoplastic resin composition. The thermoplastic resin composition further contains a phenylenediamine-based or quinoline-based anti-aging agent and a processing aid.

The thermoplastic resin constituting the matrix of the thermoplastic resin composition contains, but not limited to, preferably 50 mass % or more and 100 mass % or less of polyamide with respect to the mass of the thermoplastic resin, more preferably 75 mass % or more and 100 mass % or less of polyamide with respect to the mass of the thermoplastic resin, and even more preferably 95 mass % or more and 100 mass % or less of polyamide with respect to the mass of the thermoplastic resin. When the polyamide is contained in the numerical range described above, gas barrier properties can be ensured.

Examples of the polyamide include nylon 6, nylon 66, nylon 11, nylon 12, nylon 610, a nylon 6/66 copolymer, a nylon 6/12 copolymer, nylon 46, nylon 6T, nylon 9T, and nylon MXD6, and of these, nylon 6 and a nylon 6/12 copolymer are preferred.

The thermoplastic resin constituting the matrix of the thermoplastic resin composition may contain resin other than the polyamide. Examples of the resin other than the polyamide include, but not limited to, a polyester, a polyvinylalcohol, and a polyketone.

The elastomer constituting the domain of the thermoplastic resin composition contains elastomer having a polyisobutylene backbone. The elastomer having a polyisobutylene backbone is as described above.

The content of the elastomer is preferably 30 mass % or more and 80 mass % or less, more preferably 40 mass % or more and 80 mass % or less, and even more preferably 50 mass % or more and 80 mass % or less, with respect to the mass of the thermoplastic resin composition. When the content of the elastomer is in the numerical range described above, the dispersion state of the islands-in-the-sea structure, in which the elastomer is the domain, can be ensured, and flexibility and gas barrier properties can be ensured.

The thermoplastic resin composition constituting the inner layer preferably contains a phenylenediamine-based or quinoline-based anti-aging agent. When the thermoplastic resin composition contains a phenylenediamine-based or quinoline-based anti-aging agent, heat aging resistance is improved.

The phenylenediamine-based anti-aging agent refers to an anti-aging agent having, in the molecular structure thereof, an aromatic ring having two secondary amines as substituents, and is preferably at least one type selected from the group consisting of N-phenyl-N′-(1,3-dimethylbutyl)-p-phenylenediamine, N-phenyl-N′-(1-methylheptyl)-p-phenylenediamine, N-phenyl-N′-isopropyl-p-phenylenediamine, N,N′-di-2-naphthyl-p-phenylenediamine, and N,N′-diphenyl-p-phenylenediamine, and is more preferably N-phenyl-N′-(1,3-dimethylbutyl)-p-phenylenediamine.

The quinoline-based anti-aging agent refers to an anti-aging agent having a quinoline backbone in the molecular structure, and is preferably a 2,2,4-trimethyl-1,2-dihydroquinoline polymer.

The content of the phenylenediamine-based anti-aging agent or the quinoline-based anti-aging agent is preferably from 0.1 to 10 mass %, and more preferably from 0.1 to 5.0 mass %, with respect to the mass of the thermoplastic resin composition.

The thermoplastic resin composition constituting the inner layer preferably contains a processing aid. The processing aid contributes to improve extrudability of the thermoplastic resin composition.

The processing aid is not particularly limited, but is preferably at least one type selected from a fatty acid, a fatty acid metal salt, a fatty acid ester, and a fatty acid amide.

Examples of the fatty acid include stearic acid, palmitic acid, lauric acid, oleic acid, and linoleic acid, and stearic acid is preferred.

Examples of the fatty acid metal salt include calcium stearate, potassium stearate, zinc stearate, magnesium stearate, and sodium stearate, and calcium stearate is preferred.

Examples of the fatty acid ester include glycerin monostearate, sorbitan stearate, stearyl stearate, and ethylene glycol distearate.

Examples of the fatty acid amide include stearic acid monoamides, oleic acid monoamides, and ethylene bis stearic acid amides.

The content of the processing aid is preferably from 0.2 to 10 mass %, more preferably from 1 to 8 mass %, and even more preferably from 1 to 5 mass %, with respect to the mass of the thermoplastic resin composition.

The thermoplastic resin composition constituting the inner layer preferably contains a viscosity stabilizer. Blending of the viscosity stabilizer suppresses an increase in viscosity during extrusion molding of the thermoplastic resin composition, and can effectively reduce the occurrence of residual matter, and thus processability is improved.

Examples of the viscosity stabilizer include a divalent metal oxide, an ammonium salt, and a carboxylate.

Examples of the divalent metal oxide include zinc oxide, magnesium oxide, copper oxide, calcium oxide, and iron oxide. The divalent metal oxide is preferably zinc oxide or magnesium oxide, and more preferably zinc oxide.

Examples of the ammonium salt include ammonium carbonate, ammonium bicarbonate, ammonium chloride, ammonium bromide, ammonium sulfate, ammonium nitrate, ammonium acetate, and alkylammonium.

Examples of the carboxylate include sodium acetate, potassium acetate, zinc acetate, copper acetate, sodium oxalate, ammonium oxalate, calcium oxalate, and iron oxalate.

The viscosity stabilizer is most preferably zinc oxide.

The content of the viscosity stabilizer is preferably from 0.1 to 30 mass %, more preferably from 0.5 to 20 mass %, and even more preferably from 0.5 to 5 mass %, with respect to the mass of the thermoplastic resin composition.

Preferably, 50 mass % or more of the viscosity stabilizer is contained in the matrix. Blending of 50 mass % or more of the viscosity stabilizer in the matrix suppresses an increase in viscosity during extrusion molding of the thermoplastic resin composition, and can effectively reduce the occurrence of residual matter, and thus processability is improved.

The thermoplastic resin composition constituting the inner layer may contain various additives other than the components described above.

The method for producing the hose for refrigerant transportation is not particularly limited, and the hose for refrigerant transportation can be produced as follows. First, the inner layer is extruded into a tube shape by extrusion molding, then a fiber which is to serve as a reinforcing layer is braided on the tube, and further the fiber is covered with an outer layer by extrusion molding of the outer layer on the fiber.

The method for producing the hose for refrigerant transportation of an embodiment of the present technology preferably includes: preparing a composition for an outer layer by melt-kneading elastomer having a polyisobutylene backbone and crosslinkable resin; and forming an outer layer by adding a silanol condensation catalyst to the composition for an outer layer during hose extrusion molding and extrusion molding a composition to which the silanol condensation catalyst is added.

The preparing a composition for an outer layer by melt-kneading elastomer having a polyisobutylene backbone and crosslinkable resin may be also simply referred to as “melt-kneading process” below.

The melt-kneading is not limited but may be performed by using a kneader, a single screw or twin screw extruder, or the like.

The temperature during the melt-kneading is not limited as long as the melt-kneading can be performed but is preferably from 170 to 240° C.

The time for the melt-kneading is not limited as long as the target kneaded material can be prepared but is preferably from two to ten minutes.

In the melt-kneading process, the elastomer having a polyisobutylene backbone and the silane-modified resin and, optionally, various additives such as an anti-aging agent, a processing aid, and a viscosity stabilizer, are charged in a kneader or the like and melt-kneaded.

However, the silanol condensation catalyst is preferably not added in the melt-kneading process. In a case where the silanol condensation catalyst is added in the melt-kneading process, when the composition for an outer layer prepared in the melt-kneading process is brought into contact with water vapor in the atmosphere, the crosslinkable resin in the composition for an outer layer gradually crosslinks, and molding of the composition for an outer layer after the crosslinking is thus difficult. Therefore, the silanol condensation catalyst is preferably added to the composition for an outer layer during molding.

The “forming an outer layer by adding a silanol condensation catalyst to the composition for an outer layer during hose extrusion molding and extrusion molding a composition to which the silanol condensation catalyst is added” is also simply referred to as “outer layer forming process” below.

“During the extrusion molding” refers to simultaneously with the extrusion molding or within 6 hours prior to the extrusion molding.

The extrusion molding can be performed by, but not limited to, using an extruder and preferably performed by using a twin screw extruder.

The silanol condensation catalyst may be added to the composition for an outer layer before charging the composition into the extruder, the composition for an outer layer and the silanol condensation catalyst may be charged into the extruder at the same time, or the composition for an outer layer and the silanol condensation catalyst may be charged into separate feeding ports of the extruder.

The silanol condensation catalyst may be directly added to the composition for an outer layer but is preferably added as a silanol condensation catalyst-containing master batch in which resin and a silanol condensation catalyst are blended.

An outer layer is formed by extrusion-molding the composition, to which the silanol condensation catalyst has been added, onto an outer surface of the reinforcing layer.

The conditions of the extrusion molding are not limited as long as the outer layer can be formed.

The method for producing the hose for refrigerant transportation of an embodiment of the present technology preferably includes bringing the outer layer into contact with water or water vapor after the outer layer forming process (hereinafter, also simply referred to as “water contact process”). Performing the water contact process improves heat resistance of the outer layer because the crosslinkable resin in the outer layer crosslinks.

Although the crosslinkable resin in the outer layer formed by the outer layer forming process gradually crosslinks when brought into contact with water vapor in the atmosphere to form a crosslinked resin and the outer layer is crosslinked, the water contact process is preferably performed in a case where rapid crosslinking of the outer layer is desired.

Examples of the method of bringing into contact with water or water vapor include, but not limited to, a method of soaking in a water bath, a method of spraying water, and a method of placing in an atmosphere containing water vapor but is preferably a method of placing in an atmosphere containing water vapor. In the method of placing in an atmosphere containing water vapor, the outer layer is allowed to stand still in the air at a temperature of room temperature to 200° C., preferably room temperature to 100° C., and a relative humidity of 30 to 100%, preferably 40 to 90%, for one minute to one month, preferably one hour to one week, and more preferably one to four days. More specifically, the outer layer is preferably allowed to stand still in the air at a temperature of 25° C. and a relative humidity of 50% for 72 hours or longer.

In a case where the crosslinkable resin is a silane-modified resin, due to the water contact process, a hydrolyzable silyl group (preferably an alkoxysilyl group) in the silane-modified resin in the outer layer is hydrolyzed to form a silanol group, silanol groups undergo a condensation reaction to form a siloxane bond (Si—O—Si) to crosslink, and thus a crosslinked outer layer is obtained.

### Examples

### Raw Materials

The raw materials used in the following examples and comparative examples are as follows.

Nylon 6: Nylon 6 “UBE Nylon” (trade name) 1011FB, available from Ube Industries, Ltd.

Nylon 6/12: Nylon 6/12 copolymer “UBE Nylon” (trade name) 7024B, available from Ube Industries, Ltd.

Polypropylene: Propylene homopolymer “Prime Polypro” (trade name) J108M, available from Prime Polymer Co., Ltd.

Crosslinkable polypropylene: Silane-modified polypropylene “Linklon” (trade name) XPM800HM, available from Mitsubishi Chemical Corporation

IIR: Butyl rubber “Exxon Butyl” 268, available from ExxonMobil Chemical Co.

Br-IIR: Brominated butyl rubber “Exxon Bromobutyl” 2255, available from ExxonMobil Chemical Co.

Butyl rubber: Brominated isobutylene-p-methylstyrene copolymer rubber “EXXPRO” (trade name) 3745, available from ExxonMobil Chemical Co.

PP/EPDM: PP/EPDM thermoplastic elastomer “Santoprene” (trade name) 111-35, available from ExxonMobil Japan G.K.

Elastomer crosslinking agent-1: Alkylphenol-formaldehyde resin “Hitanol” (trade name) 2501Y, available from Hitachi Chemical Co., Ltd.

Elastomer crosslinking agent-2: Zinc Oxide III, available from Seido Chemical Industry Co., Ltd.

Silanol condensation catalyst: Silane crosslinking agent master batch “Catalyst MB” PZ010, available from Mitsubishi Chemical Corporation

Anti-aging agent-1: Hindered phenol-based antioxidant “IRGANOX” (trade name) 1010, available from BASF Japan Ltd.

Anti-aging agent-2: Phenylenediamine-based anti-aging agent “SANTOFLEX” (trade name) 6PPD, available from Solutia Inc. (substance name: N-phenyl-N′-(1,3-dimethylbutyl)-p-phenylenediamine)

Viscosity stabilizer: Zinc Oxide III, available from Seido Chemical Industry Co., Ltd.

Processing aid-1: Industrial stearic acid, available from Chiba Fatty Acid Co., Ltd.

Processing aid-2: Calcium stearate SC-PG, available from Sakai Chemical Industry Co., Ltd.

### Preparation of Resin Composition for Outer Layer

Resin compositions for outer layers A1, A2, A3, and A4 were prepared by the following method. The raw materials other than the silanol condensation catalyst were charged into a twin screw extruder (available from The Japan Steel Works, Ltd.) at the compounding ratios shown in Table 1, and kneaded for three minutes at 235° C. The kneaded product was extruded continuously in a strand-like form from the extruder, cooled with water, and then cut with a cutter. Thus, each of the resin compositions for outer layers A1, A2, A3, and A4 in a pellet form was obtained. The silanol condensation catalyst was added during sheet formation by an extruder in a case of measurement of water vapor permeability and strength at break. The silanol condensation catalyst was added during tube shape extrusion of the resin composition for an outer layer in a case of production of a hose for refrigerant transportation.

As the resin composition for an outer layer A5, a commercially available PP/EPDM thermoplastic elastomer “Santoprene” (trade name) 111-35 (thermoplastic elastomer in which the matrix was a polypropylene and the domain was an ethylene-propylene-diene copolymer) was used.

For each of the resin compositions for outer layers A1, A2, A3, A4, and A5, water vapor permeability and strengths at break at 25° C. and 100° C. were measured, and TB₁₀₀/TB₂₅ was calculated. The measurement results are shown in Table 1.

### Preparation of Thermoplastic Resin Composition for Inner Layer

The raw materials were charged into a twin screw extruder (available from The Japan Steel Works, Ltd.) at the compounding ratios shown in Table 2, and kneaded for three minutes at 235° C. The kneaded product was extruded continuously in a strand-like form from the extruder, cooled with water, and then cut with a cutter. And thus, each of the thermoplastic resin compositions for inner layers B1, B2, and B3 in a pellet form was obtained.

### Preparation of Hose for Refrigerant Transportation

The thermoplastic resin composition for an inner layer was extruded by an extruder into a tube shape having a thickness listed in Table 3 onto a mandrel coated in advance with a release agent. A reinforcing yarn of polyester was braided thereon using a braiding machine, after which the resin composition for an outer layer, in which the silanol condensation catalyst was added, was extruded, by an extruder, onto the reinforcing yarn in a tube shape having a thickness listed in Table 3, the mandrel was removed, and thereby a hose consisting of an inner layer, a reinforcing layer, and an outer layer was produced.

After the resin composition for an outer layer was crosslinked by allowing the produced hose to stand still in the air at a temperature of 25° C. and a relative humidity of 50% for 72 hours or longer, refrigerant permeation resistance, moisture permeation resistance, flexibility, and heat resistance were evaluated. The evaluation results are shown in Table 3.

The measurement and evaluation methods are as follows.

### Measurement of Water Vapor Permeability

A sample of the resin composition for an outer layer, in which the silanol condensation catalyst was added, was formed into a sheet with an average thickness of 0.2 mm by using a 40 mmφ single screw extruder (available from Pla Giken Co., Ltd.) equipped with a 550-mm wide T-shaped die and setting the temperatures of the cylinder and the die at 10° C. plus the melting point of the polymer component having the highest melting point in the sample composition at a cooling roll temperature of 50° C. and a take-up speed of 3 m/min. The produced sheet was allowed to stand still in the air at a temperature of 25° C. and a relative humidity of 50% for 72 hours or longer, and thus a sheet of the crosslinked resin composition was produced.

The obtained sheet was cut out and measured at a temperature of 60° C. and a relative humidity of 95% using a water vapor transmission rate tester, available from GTR Tec Corporation.

### Measurement of Strength at Break

The sheet having the average thickness of 0.2 mm produced in the measurement of water vapor permeability was allowed to stand still in the air at a temperature of 25° C. and a relative humidity of 50% for 72 hours or longer, and thus a sheet of the crosslinked resin composition was produced. The sheet of the crosslinked resin composition was punched out into a JIS No. 3 dumbbell shape and subjected to tensile tests in a condition at a temperature of 25° C. and a rate of 500 mm/min and in a condition at a temperature of 100° C. and a rate of 500 mm/min in accordance with the measurement method specified in JIS K 6251 “Rubber, vulcanized or thermoplastic-Determination of tensile stress-strain properties”. Based on the obtained stress-strain curve, a stress at break (strength at break) was determined.

Taking the strength at break at 25° C. as TB₂₅ and the strength at break at 100° C. as TB₁₀₀, a ratio TB₁₀₀/TB₂₅ was calculated. The TB₁₀₀/TB₂₅ is an indicator of heat resistance, and a TB₁₀₀/TB₂₅ closer to 1.0 indicates superior heat resistance.

### Evaluation of Refrigerant Permeation Resistance

The measurement was performed in accordance with SAE (Society of Automotive Engineers) J2064 AUG2015. Each of the test samples S having a length of 1.07 m was filled with 70%±3% refrigerant (HFO-1234yf) per 1 cm³ of the internal volume of the test sample S. This test sample S was allowed to stand in an atmosphere at 80° C. for 25 days, and an amount of reduction in the mass (amount of refrigerant permeation) per day [kg/day] was measured for a predetermined period (five days to seven days) at the end of the 25-day period. A numerical value obtained by dividing this amount of reduction by an inner surface area of the test sample S was converted into a numerical value per year to calculate a refrigerant permeation coefficient [kg/(m²·year)]. A smaller numerical value of the refrigerant permeation coefficient indicates superior refrigerant permeation resistance. A case where this numerical value was 3 or less can be evaluated as having refrigerant permeation resistance adequate for practical use. In Table 3, a case where this numerical value was 3 or less was indicated as ◯, and a case where this numerical value was more than 3 was indicated as x.

### Evaluation of Moisture Permeation Resistance

Each of the test samples S that had been left in an oven at 50° C. for 5 hours was filled with a drying agent having a volume corresponding to 80% of the inner volume of the test sample S and was then sealed. The test sample S was then left to stand in an atmosphere with a temperature of 50° C. and a relative humidity of 95%, the mass of the drying agent was measured after 120 hours and after 360 hours, and the increase in the mass of the drying agent between 120 hours and 360 hours was calculated, the increase amount of the mass during the 240-hour period was divided by the inner surface area of the test sample S, and the water vapor transmission coefficient [mg/(240 h·cm²)] was calculated. A smaller numerical value of the water vapor transmission coefficient indicates superior moisture permeation resistance. A case where this numerical value was 3 or less can be evaluated as having moisture permeation resistance adequate for practical use. In Table 1, a case where this numerical value was 3 or less was indicated as ◯, and a case where this numerical value was more than 3 was indicated as x.

### Evaluation of Flexibility

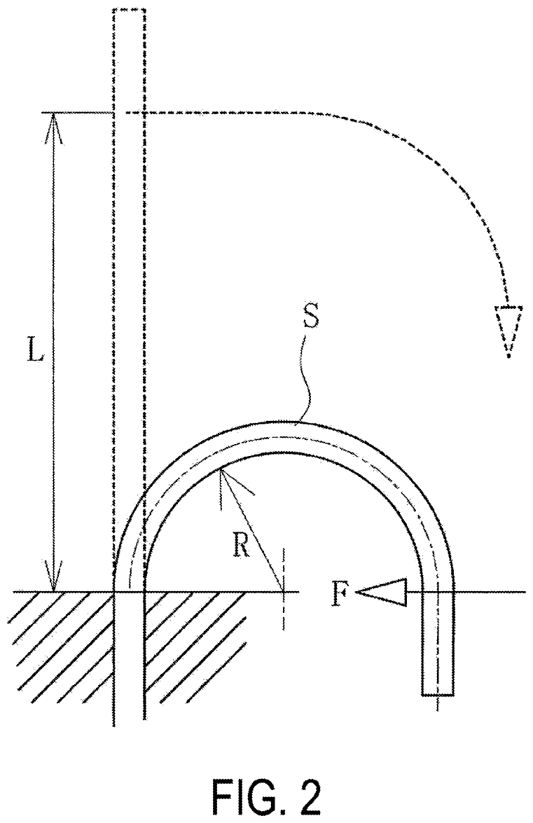

As illustrated in FIG. 2, one end portion in a length direction of each of the test samples S was fixed by a fixing tool such as a clamp, a spring balance was attached to the other end portion which was separated from the fixing position by a predetermined length L (120+hose outer diameter/2)×π [mm] and pulled, and the test sample S was bent in a semicircular arc-shape from a state illustrated by dashed lines to a state illustrated by solid lines. Then, a tensile force F measured by the spring balance that was pulling in a horizontal direction in a bent state with a radius R in a hose inner side of 120 mm was used as an indicator for evaluation. A smaller value of this tensile force F indicates ease in bending and superior flexibility of the test sample S. A case where this tensile force F was 20 N or less can be evaluated as having flexibility adequate for practical use. In Table 3, a case where this tensile force F was 20 N or less was indicated as ◯, and a case where this tensile force F was more than 20 N was indicated as x.

### Evaluation of Heat Resistance

Sealing properties of the swaging part after heat aging were confirmed by an air tightness test, in which the test sample S allowed to stand in an oven at 150° C. for 168 hours was pressurized to an internal pressure of 3.5 MPa and maintained for five minutes. A case where no leakage occurred was indicated as ◯, and a case where leakage occurred was indicated as x.

TABLE 1
Compounding proportion of resin composition for outer layer

| | | A1 | A2 | A3 | A4 | A5 |
|---|---|---|---|---|---|---|
| Crosslinkable | Parts by mass | 47 | 27 | 13 | | |
| polypropylene | | | | | | |
| Polypropylene | Parts by mass | | | 13 | 31 | |
| IIR | Parts by mass | 48 | 68 | 68 | | |
| Br-IIR | Parts by mass | | | | 67 | |
| PP/EPDM | Parts by mass | | | | | 100 |
| Elastomer crosslinking | Parts by mass | 1 | 1 | 1 | | |
| agent-1 | | | | | | |
| Elastomer crosslinking | Parts by mass | | | | 2 | |
| agent-2 | | | | | | |
| Silanol condensation | Parts by mass | 2 | 1 | 2 | | |
| catalyst | | | | | | |
| Anti-aging agent-1 | Parts by mass | 2 | 3 | 3 | | |
| Total | Parts by mass | 100 | 100 | 100 | 100 | 100 |
| Water vapor permeability | g · mm/(m² · 24 h) | 1.5 | 1.8 | 1.5 | 1.7 | 14.1 |
| TB₁₀₀/TB₂₅ | | 0.42 | 0.42 | 0.38 | 0.15 | 0.47 |

TABLE 2
Compounding proportion of thermoplastic
resin composition for inner layer

| | | B1 | B2 | B3 |
|---|---|---|---|---|
| Nylon 6 | Parts by mass | 59 | 40 | 30 |
| Nylon 6/12 | Parts by mass | | | 5 |
| Butyl-based rubber | Parts by mass | 35 | 54 | 59 |
| Anti-aging agent-2 | Parts by mass | 1.5 | 1.5 | 1.5 |
| Viscosity stabilizer | Parts by mass | 3.0 | 3.0 | 3.0 |
| Processing aid-1 | Parts by mass | 0.7 | 0.7 | 0.7 |
| Processing aid-2 | Parts by mass | 0.8 | 0.8 | 0.8 |
| Total | Parts by mass | 100 | 100 | 100 |

TABLE 3-1
Configuration and evaluation of hose

| | | | Example 1 | Example 2 | Example 3 | Example 4 |
|---|---|---|---|---|---|---|
| Inner layer | Composition | | B3 | B3 | B3 | B1 |
| | Layer thickness | mm | 0.8 | 0.8 | 0.8 | 0.8 |
| Reinforcing | Material | | Polyester | Polyester | Polyester | Polyester |
| layer | Layer thickness | mm | 1.0 | 0.5 | 0.5 | 0.5 |
| | Inclination angle | ° | 55 | 55 | 55 | 55 |
| | Structure | | Spiral | Spiral | Spiral | Spiral |
| | Number of layers | | 2 | 1 | 1 | 1 |
| Outer layer | Composition | | A1 | A2 | A3 | A1 |
| | Layer thickness | mm | 0.6 | 1.6 | 1.6 | 1.6 |
| Evaluation | Refrigerant | | ∘ | ∘ | ∘ | ∘ |
| | permeation resistance | | | | | |
| | Moisture permeation | | ∘ | ∘ | ∘ | ∘ |
| | resistance | | | | | |
| | Flexibility | | ∘ | ∘ | ∘ | ∘ |
| | Heat resistance | | ∘ | ∘ | ∘ | ∘ |

TABLE 3-2
Configuration and evaluation of hose

| | | | | | Comparative | Comparative |
|---|---|---|---|---|---|---|
| | | | Example 5 | Example 6 | Example 1 | Example 2 |
| Inner layer | Composition | | B2 | B3 | B3 | B3 |
| | Layer thickness | mm | 0.8 | 0.8 | 0.8 | 0.8 |
| | Material | | Polyester | Polyester | Polyester | Polyester |
| Reinforcing | Layer thickness | mm | 0.5 | 0.5 | 0.5 | 0.5 |
| layer | Inclination angle | ° | 55 | 55 | 55 | 55 |
| | Structure | | Spiral | Braided | Spiral | Spiral |
| | Number of layers | | 1 | 1 | 1 | 1 |
| Outer layer | Composition | | A2 | A1 | A4 | A5 |
| | Layer thickness | mm | 1.6 | 0.6 | 0.6 | 1.6 |
| Evaluation | Refrigerant | | ∘ | ∘ | ∘ | ∘ |
| | permeation resistance | | | | | |
| | Moisture permeation | | ∘ | ∘ | ∘ | x |
| | resistance | | | | | |
| | Flexibility | | ∘ | ∘ | ∘ | ∘ |
| | Heat resistance | | ∘ | ∘ | x | ∘ |

The hose for refrigerant transportation according to an embodiment of the present technology can be suitably used for transporting a refrigerant for an air conditioner and the like of an automobile and the like.

1. A hose for refrigerant transportation, the hose comprising:
an outer layer;
a reinforcing layer; and
an inner layer;
the outer layer being composed of a resin composition containing elastomer having a polyisobutylene backbone and crosslinked resin,
a content of the elastomer having a polyisobutylene backbone in the resin composition being 30 mass % or more and 90 mass % or less with respect to a mass of the resin composition,
a content of the crosslinked resin in the resin composition being 10 mass % or more and 70 mass % or less with respect to the mass of the resin composition,
a water vapor permeability of the resin composition being 2.0 g·mm/(m²·24 h) or less, and
a ratio TB₁₀₀/TB₂₅ of a strength at break TB 100 of the resin composition at 100° C. to a strength at break TB₂₅ of the resin composition at 25° C. being from 0.2 to 1.0.

2. The hose for refrigerant transportation according to claim 1, wherein the crosslinked resin is crosslinked silane-modified resin obtained by modifying thermoplastic resin with a silane compound.

3. The hose for refrigerant transportation according to claim 2, wherein the crosslinked resin is crosslinked silane-modified polyolefin obtained by modifying polyolefin with a silane compound.

4. The hose for refrigerant transportation according to claim 3, wherein the crosslinked resin is crosslinked silane-modified polypropylene obtained by modifying polypropylene with a silane compound.

5. The hose for refrigerant transportation according to claim 1, wherein
the elastomer having a polyisobutylene backbone is butyl rubber or modified butyl rubber, and
the elastomer having a polyisobutylene backbone is dynamically crosslinked.

6. The hose for refrigerant transportation according to claim 1, wherein the resin composition contains 1 mass % or more and 4 mass % or less of an anti-aging agent with respect to the mass of the resin composition.

7. The hose for refrigerant transportation according to claim 1, wherein
the inner layer is composed of a thermoplastic resin composition,
the thermoplastic resin composition has an islands-in-the-sea structure in which elastomer is present as a domain in a matrix containing the thermoplastic resin,
the thermoplastic resin contains 50 mass % or more and 100 mass % or less of polyamide with respect to the mass of the thermoplastic resin,
the elastomer contains the elastomer having a polyisobutylene backbone,
a content of the elastomer is 30 mass % or more and 80 mass % or less with respect to the mass of the thermoplastic resin composition, and
the thermoplastic resin composition further contains a phenylenediamine-based or quinoline-based anti-aging agent and a processing aid.

8. The hose for refrigerant transportation according to claim 1, wherein the reinforcing layer contains a polyester fiber, a polyamide fiber, an aramid fiber, a PBO fiber, a vinylon fiber, or a rayon fiber.

9. A method for producing the hose for refrigerant transportation according to claim 1, the method comprising:
preparing a composition for an outer layer by melt-kneading elastomer having a polyisobutylene backbone and crosslinkable resin; and
forming an outer layer by adding a silanol condensation catalyst to the composition for an outer layer during hose extrusion molding and extrusion molding a composition to which the silanol condensation catalyst is added.

10. The method according to claim 9, wherein the crosslinkable resin is silane-modified resin obtained by modifying thermoplastic resin with a silane compound.

11. The hose for refrigerant transportation according to claim 4, wherein
the elastomer having a polyisobutylene backbone is butyl rubber or modified butyl rubber, and
the elastomer having a polyisobutylene backbone is dynamically crosslinked.

12. The hose for refrigerant transportation according to claim 11, wherein the resin composition contains 1 mass % or more and 4 mass % or less of an anti-aging agent with respect to the mass of the resin composition.

13. The hose for refrigerant transportation according to claim 12, wherein
the inner layer is composed of a thermoplastic resin composition,
the thermoplastic resin composition has an islands-in-the-sea structure in which elastomer is present as a domain in a matrix containing the thermoplastic resin,
the thermoplastic resin contains 50 mass % or more and 100 mass % or less of polyamide with respect to the mass of the thermoplastic resin,
the elastomer contains the elastomer having a polyisobutylene backbone,
a content of the elastomer is 30 mass % or more and 80 mass % or less with respect to the mass of the thermoplastic resin composition, and
the thermoplastic resin composition further contains a phenylenediamine-based or quinoline-based anti-aging agent and a processing aid.

14. The hose for refrigerant transportation according to claim 13, wherein the reinforcing layer contains a polyester fiber, a polyamide fiber, an aramid fiber, a PBO fiber, a vinylon fiber, or a rayon fiber.

15. A method for producing the hose for refrigerant transportation according to claim 14, the method comprising:
preparing a composition for an outer layer by melt-kneading elastomer having a polyisobutylene backbone and crosslinkable resin; and
forming an outer layer by adding a silanol condensation catalyst to the composition for an outer layer during hose extrusion molding and extrusion molding a composition to which the silanol condensation catalyst is added.

16. The method according to claim 15, wherein the crosslinkable resin is silane-modified resin obtained by modifying thermoplastic resin with a silane compound.
